(19) United States
(12) Patent Application Publication
(10) Pub. No.: US 2019/0075365 A1
(43) Pub. Date: Mar. 7, 2019

(54) REMINDING A USER OF AN ONLINE SYSTEM ABOUT A CONTENT ITEM PRESENTED TO THE USER IN CONJUNCTION WITH A VIDEO

(71) Applicant: Facebook, Inc., Menlo Park, CA (US)

(72) Inventors: Asad K. Awan, San Francisco, CA (US); Hong Yan, Los Altos, CA (US); Abhishek Bapna, Mountain View, CA (US); Maria Angelidou, Menlo Park, CA (US)

(21) Appl. No.: 15/697,707

(22) Filed: Sep. 7, 2017

(51) Int. Cl. H04N 21/488; H04N 21/45; H04N 21/432; H04N 21/8545; H04N 21/435; H04N 21/431

(52) U.S. Cl. CPC H04N 21/4882; H04N 21/4532; H04N 21/4312; H04N 21/8545; H04N 21/435; H04N 21/432

(57) ABSTRACT

An online system allows online system users to search for and view content (e.g., videos) maintained in the online system. The online system may maintain user accounts associated with each user, which allow the online system to identify the users across different sessions within the online system. Upon receiving a request to present a video to a viewing user of the online system, the online system may present a content item in conjunction with the video, such that the content item overlays at least a portion of the video. The content item may be presented in conjunction with an interactive element corresponding to an option to receive a reminder associated with the content item. If the online system receives a request from the viewing user to receive the reminder associated with the content item, the online system may send the reminder to the viewing user at a later time.

### BACKGROUND

This disclosure relates generally to online systems, and more specifically to reminding a user of an online system about a content item presented in conjunction with a video.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for users to share content by creating content items (e.g., advertisements) for presentation to additional online system users. For example, users may share photos or videos they have uploaded by creating content items that include the photos or videos that are presented to additional users to whom they are connected in the online system. By allowing users to create content items for presentation to additional online system users, an online system also provides abundant opportunities to persuade online system users to take various actions and/or to increase awareness about products, services, opinions, or causes among online system users. For example, an advertiser may create a direct response advertisement to generate an immediate response from online system users presented with the advertisement (e.g., to purchase a product associated with the advertisement).

Online systems also may allow their users to search for and view content maintained in the online systems. Content maintained in an online system may be associated with information describing the content that is provided by users of the online system at the time the content is uploaded to the online system. For example, when uploading a video to an online system, an online system user may include a title for the video and a short description of its contents. Online system users may search for content maintained in an online system based on information associated with the content. For example, an online system user may search for videos related to certain topics by providing search parameters to an online system that include keywords associated with the topics.

To encourage online system users (e.g., advertisers) to provide content items (e.g., advertisements) for presentation to other online system users, online systems conventionally identify opportunities to present content items to online system users in conjunction with other types of content maintained in the online system. For example, the online system may identify an opportunity to present a content item to an online system user upon receiving a request from the user to present a video maintained in the online system. In this example, the online system may present an advertisement in conjunction with the video by overlaying the advertisement onto a display area in which the video is being presented while the video is playing. Alternatively, in the above example, upon receiving a request from the user to play the video, the advertisement may be presented in the display area in which the video is to be presented prior to playing the video.

However, online system users who request the presentation of various types of content maintained in an online system may find it distracting or frustrating to be presented with advertisements or other content items before or during presentation of the requested content. For example, an online system user may find it distracting if a content item not specifically requested by the user is overlaid onto a portion of a video that they are trying to watch. In this example, since the user's attention is focused on the video rather than on the content item, the user may close the content item to prevent it from obstructing their view of the video without being aware of whether they may have been interested in the content item. As an additional example, if the online system receives a request from an online system user to watch a 10-second video, the online system may first require a 30-second commercial to be presented before the requested video is played. In this example, the online system user may find it frustrating that they must watch a commercial that is three times as long as the requested video and decide to navigate away from the online system before the commercial has finished playing and before the requested video is even presented. Thus, by presenting content items to online system users in conjunction with other types of content, an online system may discourage user engagement with the online system and decrease the number of opportunities it has to present content items to online system users.

### SUMMARY

An online system, such as an online media sharing service, allows viewing users of the online system to search for and view content (e.g., videos) maintained in the online system. For example, viewing users of the online system may search for videos by entering various search parameters (e.g., keywords) into a search field included in a user interface presented by the online system. In this example, upon receiving search parameters from a viewing user of the online system, the online system may present a set of results that includes videos that are associated with information that matches at least a threshold number of the search parameters; the viewing user may then select a video from the set of results to view it.

The online system may maintain a user account for each user of the online system, which allows the online system to identify online system users across different sessions within the online system. Login credentials (e.g., a username/email address and password combination) or other user-identifying information that is associated with each user in the online system may be stored in association with a user account for the user. The online system may identify users across different sessions within the online system based on login credentials provided by each user at the start of each session. The online system also may identify users across different sessions within the online system using other tracking mechanisms (e.g., cookies). For example, when a user of the online system requests to access a page maintained in the online system, if the request does not include a cookie identifier, the online system may set a cookie in a client device from which the request was received by generating a cookie identifier that is unique to the user in the online system and by storing the cookie identifier in the client device. In this example, the online system also may store the cookie identifier in association with a user account for the user so that if the online system subsequently receives an additional request from the user to access a page maintained in the online system, the request may include the cookie identifier, allowing the user to be identified by the online system.

Upon receiving a request from a viewing user of the online system to view a video, the online system may identify the viewing user (e.g, using login credentials or tracking mechanisms, as described above), as well as one or more content items maintained in the online system (e.g., advertisements) to present to the viewing user in conjunction with the requested video. In some embodiments, the online system may identify a content item to present to the viewing user in conjunction with the video by selecting the content item from various content items maintained in the online system. For example, the online system may select a set of candidate content items maintained in the online system to present to a viewing user in conjunction with a video based on attributes associated with the viewing user (e.g., type of client device used by the viewing user to access the online system) that satisfy one or more targeting criteria associated with each candidate content item. In this example, the online system may then compute a score for each candidate content item that indicates a predicted affinity of the viewing user for the candidate content item and rank the candidate content items based on their scores. Continuing with this example, the online system may select one or more of the highest ranked candidate content items for presentation to the viewing user in conjunction with the video.

The online system may identify a content item to present to the viewing user in conjunction with the video when certain conditions are met. In some embodiments, the online system identifies a content item to present to the viewing user in conjunction with the video after the online system receives a given number of requests to present videos to the viewing user. For example, for every five requests received by the online system to present videos to a viewing user of the online system, the online system identifies a content item to present to the viewing user in conjunction with the video presented in response to the fifth request. In some embodiments, the online system may identify a content item to present to the viewing user in conjunction with the video if the online system has received a minimum number of requests to present videos to the viewing user. For example, for every three requests received by the online system to present videos to a viewing user, the online system identities a content item to present to the viewing user in conjunction with at least one of the videos presented in response to the three requests. In embodiments in which the online system identifies a content item to present to the viewing user in conjunction with the video based on a given or on a minimum number of requests to present videos to the viewing user, the given/minimum number of requests may be determined based on information specified by a content-providing user of the online system associated with the content item (e.g., an advertiser who provided an advertisement to the online system).

The online system may determine the conditions under which content items may be presented to viewing users of the online system in conjunction with videos. In some embodiments, the online system may experiment with presenting content items to viewing users in conjunction with videos at various times and determine a set of optimal conditions under which content items should be presented to viewing users in conjunction with videos. For example, the online system may vary the frequency with which content items are presented to the same viewing users of the online system in conjunction with videos, as well as the times at which the content items are presented while the videos are playing. In this example, the online system may determine optimal times during which content items should be presented in conjunction with videos based on the viewing users' responses (e.g., based on whether the viewing users clicked on the content items, closed the content items, navigated away from the online system, etc.) Continuing with this example, the online system may determine that content items should be presented in conjunction with videos upon receiving every four requests from the same viewing user to view videos and that content items should be presented in conjunction with videos at the time the videos begin playing.

Once the online system has identified a content item to present to the viewing user of the online system in conjunction with the video, the online system may generate a user interface in which to present the content item and the video. The user interface may include a display area in which a content item and the video may be presented. In some embodiments, a content item and the video may be arranged within the display area of the user interface such that the content item overlays at least a portion of the video. For example, the online system may arrange a video and a content item in a display area of a user interface by overlaying the content item onto the video, such that when the user interface is presented to a viewing user, at least a portion of the video onto which the content item is overlaid is not visible or is only partially visible (e.g., if the content item is partially transparent). In embodiments in which the online system identifies multiple content items to present to the viewing user, the content items may be arranged within the display area of the user interface such that one or more of the content items overlay at least a portion of the video. The user interface also may include a set of interactive elements (e.g., buttons) associated with a content item to be presented in conjunction with the video. In embodiments in which the online system identifies multiple content items to present to the viewing user, the user interface also may include multiple sets of interactive elements associated with each content item.

Each interactive element associated with a content item to be presented in conjunction with the video may correspond to an option associated with the content item that may be selected by the viewing user. In some embodiments, an interactive element associated with a content item may correspond to an option to close the content item. For example, if a viewing user is presented with a content item (e.g., a direct response advertisement associated with a service subscription) and the viewing user has no interest in the content item, the viewing user may click on a button presented with the content item corresponding to an option to close the content item (e.g., a “Close” button or a button marked with an “X”).

An interactive element associated with a content item also may correspond to an option to perform an action associated with the content item (e.g., an option to make a purchase associated with the content item, an option to visit a website associated with the content item, etc.). For example, if a viewing user is presented with a content item associated with a product and is interested in the content item, the viewing user may click on a “Buy Now” button presented with the content item corresponding to an option to purchase the product. In this example, by clicking on the “Buy Now” button, the viewing user may be redirected to a landing page associated with the content item at which the viewing user may purchase the product.

In some embodiments, an interactive element associated with a content item also may correspond to an option to receive a reminder associated with the content item at a later time. For example, if a viewing user is interested in a content item presented in conjunction with a video, but does not want to interrupt the presentation of the video, the viewing user may click on a “Remind Me Later” button corresponding to an option to receive a reminder associated with the content item at a later time. In embodiments in which an option associated with a content item includes an option to receive a reminder associated with the content item at a later time, the online system may present additional options associated with the reminder upon receiving a request from a viewing user to receive the reminder associated with the content item. For example, the online system may allow a viewing user to specify when they would like to receive a reminder (e.g., a date and a time) and how they would like to receive the reminder (e.g., in a newsfeed associated with their user account, via email or instant message, etc.).

Once the online system has generated the user interface in which to present a content item and the video, the online system may send the user interface for display to the viewing user. A content item may be presented in conjunction with the video via the user interface at any time after the online system receives a request from the viewing user to begin to play the video, but before the online system receives information indicating that the video has finished playing. For example, when a user interface is sent for display to a viewing user, a content item may be presented in conjunction with a video in a display area of the user interface at the time the video begins to play. Alternatively, in the above example, when the user interface is sent for display to the viewing user, the content item may be presented in conjunction with the video in the display area a few seconds after the video begins to play. In various embodiments, the online system may present a set of interactive elements associated with a content item at the same time that the content item is presented, while in other embodiments, the online system may delay the presentation of the set of interactive elements associated with the content item (e.g., a few seconds after the content item is initially presented) In some embodiments, once the viewing user selects an option associated with a content item, the content item is removed from the display area of the user interface in which the video is presented. For example, if a content item is overlaid onto a video in a display area of a user interface presented to a viewing user and the viewing user clicks on a button corresponding to an option to close the content item or to receive a reminder associated with the content item at a later time, the content item is removed from the display area.

In some embodiments, upon presenting a content item to the viewing user in conjunction with the video, the online system may communicate information describing the presentation of the content item to a content-providing user of the online system associated with the content item. Information describing the presentation of a content item may include information describing an impression of the content item or an action performed by the viewing user in association with being presented with the content item. For example, a content item may be associated with one or more bid amounts previously provided by a content-providing user of the online system (e.g., an advertiser) associated with the content item that specify prices the content-providing user is willing to pay in exchange for each impression of the content item or for each conversion associated with the content item. In this example, the content-providing user may be charged the bid amount when the online system presents the content item to a viewing user of the online system, when the online system receives a request from a viewing user of the online system to receive a reminder associated with the content item at a later time, or when the online system receives a request from a viewing user of the online system to perform an action associated with the content item.

After presenting a content item to the viewing user in conjunction with the video, if the online system subsequently receives a request from the viewing user to receive a reminder associated with the content item at a later time, the online system may store information associated with the content item in association with a user account for the viewing user maintained in the online system. In some embodiments, information associated with a content item that may be stored in association with a user account may include images, text, or other content included in the content item, metadata associated with the content item, information describing a set of options associated with the content item, etc. For example, suppose the online system receives a request from a viewing user to receive a reminder associated with a content item, in which the content item is associated with an upcoming music concert. In this example, the online system may store information in association with a user account for the viewing user describing a date, a time, and a location of the concert, names of one or more musicians who will be performing at the concert, a genre associated with the music, a website at which tickets for the concert may be purchased, etc. In some embodiments, the online system also may store information describing the viewing user's request to receive a reminder associated with a content item in association with their user account. For example, if the online system receives a request to remind a viewing user about a content item by email on a specific date, the online system may store information in association with a user account for the viewing user maintained in the online system including an identifier associated with the content item, the specified date, and an indication that the reminder is to be sent via email

In some embodiments, if the online system has received a request from the viewing user to receive a reminder associated with a content item, the online system may identify an opportunity to send the reminder to the viewing user. In one embodiment, the online system identifies such an opportunity upon receiving information indicating that the video that was presented in conjunction with the content item has finished playing. For example, the online system may send a reminder associated with a content item to a viewing user upon receiving information indicating that the viewing user has navigated away from the online system or from a video presented in conjunction with the content item. The online system also may identify an opportunity to send a reminder associated with a content item to the viewing user based on contextual information associated with the viewing user and/or with the content item. For example, if a content item is associated with a game application and with an option to install the game application, the online system may send a reminder associated with the content item to a viewing user at a time that would allow the application to be installed under optimal conditions (e.g, when the online system detects that a client device associated with the viewing user is connected to a WiFi network) In embodiments in which the viewing user specifies a time at which they would like to receive a reminder associated with a content item, the online system may identify an opportunity to send a reminder associated with the content item at the time specified by the viewing user. In some embodiments, the online system may identify an opportunity to send a reminder associated with a content item to the viewing user upon receiving a request to access content associated with the viewing user's user account. For example, the online system may identify an opportunity to send a reminder associated with a content item to a viewing user upon receiving a request from the viewing user to access a user profile page or an inbox associated with the viewing user's user account.

Upon identifying an opportunity to send a reminder associated with a content item to the viewing user, the online system may generate the reminder associated with the content item based on information associated with the content item. In embodiments in which information associated with a content item about which the viewing user has requested to be reminded is stored in association with a user account for the viewing user, the online system may retrieve this information and generate the reminder based on the retrieved information. For example, if the online system previously stored an identifier associated with a content item in association with a user account for a viewing user in response to receiving a request from the viewing user to receive a reminder associated with the content item at a later time, the online system may retrieve the identifier associated with the content item upon identifying an opportunity to send the reminder to the viewing user. In this example, based on the identifier associated with the content item, the online system may access the content item maintained in the online system and retrieve additional information associated with the content item (e.g., metadata associated with the content item, an image included in the content item, audio data associated with the content item, goods or services featured in the content item, etc.) and generate the reminder based on the retrieved information.

In various embodiments, the reminder generated by the online system to remind the viewing user about a content item also may be a content item. For example, upon identifying an opportunity to send a reminder associated with a content item to a viewing user of the online system, the online system may generate a reminder associated with the content item in the form of an additional content item. In this example, the additional content item may include the contents of the content item about which the viewing user requested to be reminded and interactive elements corresponding to options associated with the content item that were originally presented with the content item (e.g., an option to make a purchase associated with the content item)

In some embodiments, upon identifying an opportunity to send a reminder associated with a content item to the viewing user, the online system also may generate a user interface in which to present the reminder associated with the content item. In embodiments in which the online system generates a reminder associated with a content item in the form of an additional content item, the user interface generated by the online system in which to present the reminder may be a feed of content items that includes this additional content item. For example, the online system may identify an opportunity to send a reminder associated with a content item to a viewing user upon receiving a request from the viewing user to access a user profile page associated with the viewing user. In this example, the online system may generate a newsfeed that is specific to the viewing user that includes content items reminding the viewing user about other content items.

In various embodiments, the online system generates a dashboard that allows the viewing user to view one or more content items about which the viewing user has requested to be reminded and to perform various actions associated with these content items. For example, upon receiving a request from a viewing user to access a user profile page associated with the viewing user, the online system may generate a dashboard that includes a content item associated with an application about which the viewing user has requested to be reminded. In this example, the dashboard also may include a set of buttons that each correspond to various options associated with the content item that may be selected by the viewing user (e.g., an option to install the application, an option to receive a reminder associated with the content item at a later time, an option to share the content item with additional users of the online system, etc.).

The online system may send a reminder associated with a content item to the viewing user using various mechanisms. In some embodiments, the online system may send a reminder associated with a content item to a viewing user using one or more types of notifications. Examples of notifications include alerts, text messages, emails, or any other suitable types of notifications. For example, the online system may send a notification to remind a viewing user about a content item via a pop-up window. As an additional example, the online system may send a message to an inbox associated with a viewing user's account maintained in the online system reminding the viewing user about a content item and notify the viewing user of the message by email. In embodiments in which the online system generates a user interface in which to present a reminder associated with a content item, the online system may send the reminder associated with the content item to the viewing user via the user interface (e.g., in a newsfeed or in a dashboard).

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for reminding a user of an online system about a content item presented to the user in conjunction with a video, in accordance with an embodiment.

FIG. 4 is an example user interface in which to present a content item to a user of an online system in conjunction with a video, in accordance with an embodiment.

FIG. 5 is an example newsfeed in which to present a reminder associated with a content item to a user of an online system, in accordance with an embodiment.

FIG. 6A is an example dashboard in which to present a reminder associated with a content item to a user of an online system, in accordance with an embodiment.

FIG. 6B is an additional example dashboard in which to present a reminder associated with a content item to a user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

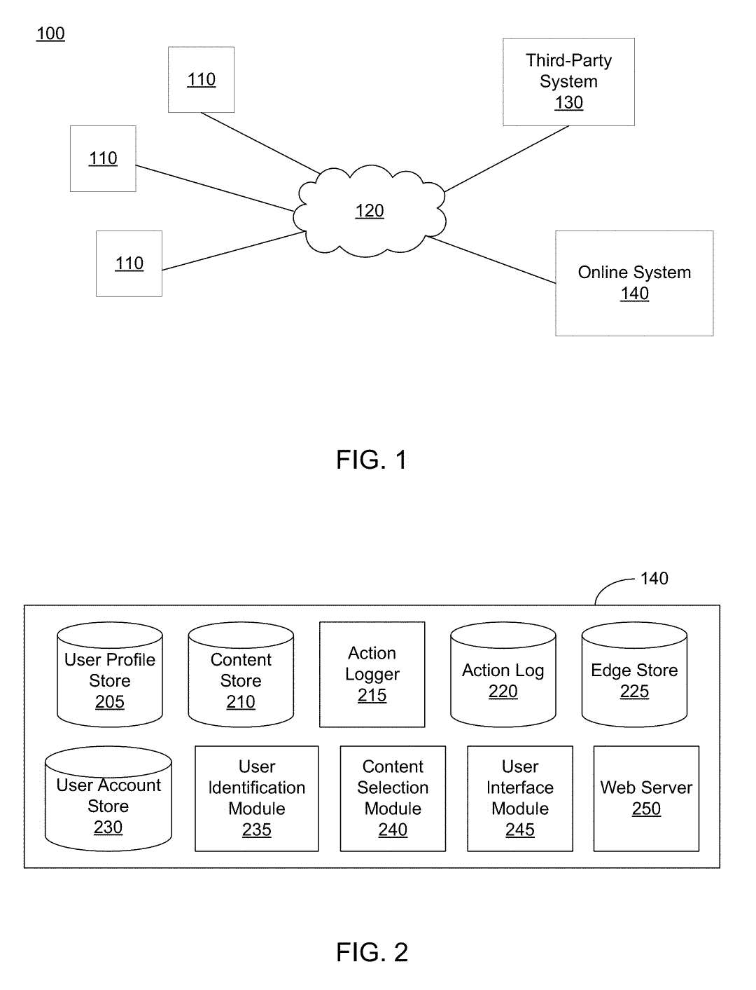

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

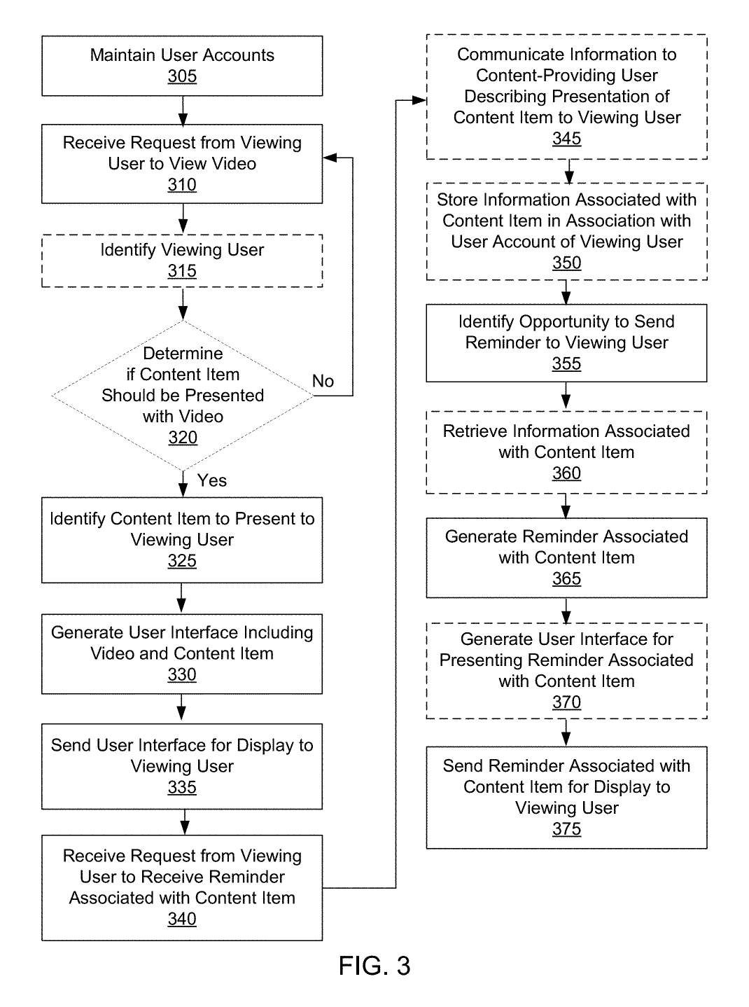

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher) provides content or other information for presentation via a client device 110. A third-party system 130 also may communicate information to the online system 140, such as advertisements, content, or information about an application provided by the third-party system 130.

FIG. 2 is a block diagram of an architecture of the online system 140. The online system 140 shown in FIG. 2 includes a user profile store 205, a content store 210, an action logger 215, an action log 220, an edge store 225, a user account store 230, a user identification module 235, a content selection module 240, a user interface module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

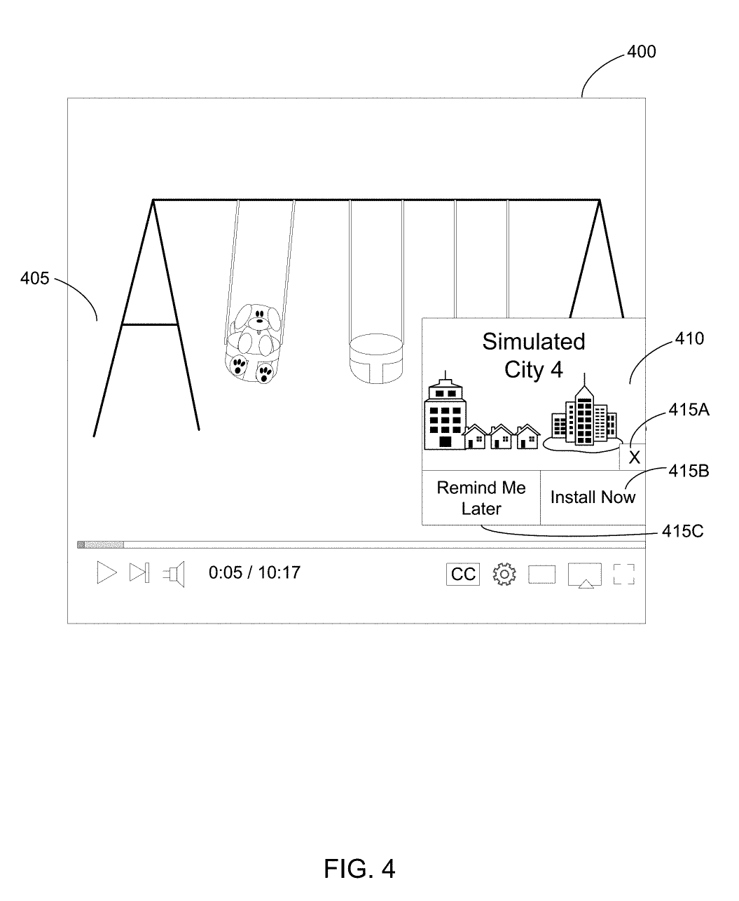

User accounts for users of the online system 140 may be stored or maintained (e.g., as shown in step 305 of FIG. 3) in the user account store 230. Various types of user-identifying information that is associated with a user in the online system 140 may be stored in association with a user account for the online system user. In some embodiments, user-identifying information that is stored in the user account store 230 includes login credentials (e.g., a username or an email address) for a user. For example, when a prospective user of the online system 140 requests to create a user account in the online system 140, the online system 140 may require the user to provide a username that is unique to the user in the online system 140 and a password. In this example, upon receiving a username and a password from the user, the online system 140 stores the username and the password in association with a user account that is created for the user.

User-identifying information that is stored in the user account store 230 also may include information associated with tracking mechanisms (e.g., cookies). For example, when a user of the online system 140 requests to access a page maintained in the online system 140, if the request does not include a cookie identifier, the online system 140 may generate a cookie identifier that is unique to the user in the online system 140 and store the cookie identifier in a client device 110 from which the request was received. In this example, the online system 140 also may store the cookie identifier in association with a user account for the user in the user account store 230.

In some embodiments, user-identifying information that is stored in the user account store 230 also may include information associated with client devices 110 associated with users of the online system 140. For example, when the online system 140 receives login credentials from a user of the online system 140, the online system 140 also may receive a client device identifier (e.g, an IP address) in conjunction with the login credentials that are associated with a client device 110 from which the login credentials were received. In this example, if the online system 140 determines that the login credentials are valid (i.e., if the online system 140 determines that the login credentials are associated with a user account maintained in the user account store 230), the online system 140 may store the client device identifier in association with the user account. In the above example, the online system 140 also may store additional types of information associated with the client device 110 in association with the user account, such as a browser identifier, an operating system identifier, etc.

In various embodiments, user-identifying information that is stored in the user account store 230 may include various types of information that also is stored in the user profile store 205. For example, each user account for a user of the online system 140 may be stored in association with a first name, a last name, and a birthdate of the user. As an additional example, each user account for an online system user may be stored in association with an email address, a home address, and a phone number associated with the user.

In some embodiments, information associated with a content item for which an online system user has requested to receive a reminder may be stored (e.g., as shown in step 350 of FIG. 3) in the user account store 230 in association with a user account for the user. Information associated with a content item that may be stored in association with a user account may include images, text, or other content included in the content item, metadata associated with the content item, information describing a set of options associated with the content item, etc. For example, if the online system 140 receives a request from a user to receive a reminder associated with a content item about a movie that is coming soon to theaters, information associated with the content item stored in association with the user's user account may include a date the movie will arrive in theaters, the names and locations of theaters that will be playing the movie, the names of one or more actors who star in the movie, a genre associated with the movie, a website at which tickets for the movie may be purchased, etc.

In some embodiments, information describing a request received from an online system user to receive a reminder associated with a content item may be stored in association with a user account for the user in the user account store 230. For example, if the online system 140 receives a request to remind an online system user about a content item by email on a specific date, the online system 140 may store information in the user account store 230 in association with a user account for the user including an identifier associated with the content item, the specified date, and an indication that the reminder is to be sent via email. As an additional example, if the online system 140 receives a request to remind an online system user about a content item in a pop-up window an hour later, the online system 140 may store information in association with a user account for the user including information associated with the content item, the time that the online system 140 received the request to remind the user about the content item, and an indication that the reminder is to be sent in a pop-up window an hour after the request was received. The user account store 230 is further described below in conjunction with FIG. 3.

The user identification module 235 identifies (e.g., as shown in step 315 of FIG. 3) users of the online system 140 across different sessions within the online system 140. The user identification module 235 may identify users of the online system 140 based on various types of user-identifying information that is unique to each user in the online system 140. In some embodiments, the user identification module 235 may identify users of the online system 140 based on login credentials (e.g., a username/email address and password combination) for each user. For example, the online system 140 may require each user of the online system 140 to provide login credentials at the start of each session in the online system 140. In this example, when the online system 140 receives login credentials from a user, the user identification module 235 may access the user account store 230 and identify the user to be the online system user having a user account associated with the login credentials.

In various embodiments, the user identification module 235 may identify users of the online system 140 across different sessions within the online system 140 using one or more tracking mechanisms (e.g., cookies). For example, when a user of the online system 140 requests to access a page maintained in the online system 140, if the request includes a cookie identifier, the user identification module 235 may access the user account store 230 and identify the user to be the online system user having a user account associated with the cookie identifier. The functionality of the user identification module 235 is further described below in conjunction with FIG. 3.

The content selection module 240 may determine (e.g., as shown in step 320 of FIG. 3) if a content item should be presented to a viewing user of the online system 140 in conjunction with a video. The content selection module 240 may determine that a content item should be presented to a viewing user in conjunction with a video if certain conditions are met. In some embodiments, the content selection module 240 determines that a content item should be presented to a viewing user in conjunction with a video if the online system 140 has received a given number of requests to present videos to the viewing user. For example, the content selection module 240 determines that for every five requests received by the online system 140 to present videos to a viewing user of the online system 140, a content item should be presented to the viewing user in conjunction with the video presented in response to the fifth request. In some embodiments, the content selection module 240 may determine that a content item should be presented to a viewing user in conjunction with a video if the online system 140 has received a minimum number of requests to present videos to the viewing user. For example, the content selection module 240 determines that for every three requests received by the online system 140 to present videos to a viewing user, a content item should be presented to the viewing user in conjunction with at least one of the videos presented in response to the three requests

In embodiments in which the content selection module 240 determines if a content item should be presented to a viewing user in conjunction with a video based on a given or on a minimum number of requests to present videos to the viewing user, the given/minimum number of requests may be determined based on information specified by a content-providing user of the online system 140 associated with the content item. For example, if a content item is an advertisement, an advertiser who provided the advertisement to the online system 140 may specify that the advertisement should be presented 100 times per day. In this example, based on the information specified by the advertiser, the content selection module 240 may adjust the frequency with which the advertisement is presented to viewing users of the online system 140 in order to achieve the 100 presentations per day.

The content selection module 240 may determine the conditions under which content items should be presented to viewing users in conjunction with videos. In some embodiments, the content selection module 240 experiments with presenting content items to viewing users in conjunction with videos at various times and determines a set of optimal conditions under which the content items should be presented to viewing users in conjunction with videos. For example, the content selection module 240 may vary the frequency with which content items are presented to the same viewing users in conjunction with videos and the times at which content items are presented while the videos are playing. In this example, the content selection module 240 may determine optimal times during which content items should be presented in conjunction with videos based on the viewing users' responses (e.g., based on whether the viewing users clicked on the content items, closed the content items, navigated away from the online system 140, etc.). Continuing with this example, the content selection module 240 may determine that content items should be presented in conjunction with videos upon receiving every four requests from the same viewing user to view videos and that content items should be presented in conjunction with videos at the time the videos begin playing.

The content selection module 240 also may identify (e.g., as shown in step 325 of FIG. 3) a set of content items to present to a viewing user in conjunction with a video. In some embodiments, the content selection module 240 may identify a set of content items to present to a viewing user in conjunction with a video by selecting the set of content items from various content items maintained in the online system 140. For example, the content selection module 240 may select a set of candidate content items maintained in the content store 210 to present to a viewing user in conjunction with a video based on attributes associated with the viewing user (e.g., demographic information associated with the viewing user stored in the user profile store 205) that satisfy one or more targeting criteria associated with each candidate content item. In this example, the content selection module 240 may then compute a score for each candidate content item that indicates a predicted affinity of the viewing user for the candidate content item and select one or more content items having the highest scores for presentation to the viewing user in conjunction with the video. The functionality of the content selection module 240 is further described below in conjunction with FIG. 3.

The user interface module 245 generates (e.g., as shown in step 330 of FIG. 3) a user interface for presenting a set of content items to a viewing user in conjunction with a video. The user interface generated by the user interface module 245 may include a display area for presenting one or more content items in conjunction with a video. In various embodiments, a video and a content item are arranged within the display area of the user interface such that the content item overlays at least a portion of the video. For example, if the user interface module 245 generates a user interface that includes a display area in which a video and a content item are to be displayed, the user interface module 245 may arrange the video and the content item in the display area by overlaying the content item onto the video, such that when the user interface is presented to a viewing user, at least a portion of the video onto which the content item is overlaid is not visible. Alternatively, in the above example, the content item may be partially transparent, such that when the user interface is presented to the viewing user, at least a portion of the video onto which the content item is overlaid is only partially visible. In embodiments in which the content selection module 240 identifies multiple content items to present to a viewing user in conjunction with a video, the content items may be arranged within the display area of the user interface such that one or more of the content items overlay at least a portion of the video. The user interface also may include a set of interactive elements (e.g., buttons) associated with a content item to be presented in conjunction with a video. In embodiments in which the content selection module 240 identifies multiple content items to present to a viewing user, the user interface also may include multiple sets of interactive elements associated with each content item.

Each interactive element associated with a content item to be presented in conjunction with the video may correspond to an option associated with the content item that may be selected by a viewing user. An example of an option associated with a content item that may be selected by a viewing user is an option to close the content item. For example, if a viewing user is presented with a content item (e.g., a direct response advertisement associated with a service subscription) and the viewing user has no interest in the content item, the viewing user may click on a button presented with the content item corresponding to an option to close the content item (e.g., a “Close” button or a button marked with an “X”).

Another example of an option associated with a content item that may be selected by a viewing user is an option to perform an action associated with the content item. In some embodiments, an option to perform an action associated with a content item may correspond to an option to make a purchase associated with the content item, an option to visit a website associated with the content item, an option to express a preference for the content item, an option to share the content item, an option to comment on the content item, an option to sign a petition associated with the content item, an option to try a sample associated with the content item, etc. For example, if a viewing user is presented with a content item associated with a petition and the viewing user is interested in the content item, the viewing user may click on a “Sign Now” button presented with the content item corresponding to an option to sign the petition. In this example, by clicking on the “Sign Now” button, the viewing user may be redirected to a landing page associated with the content item at which the viewing user may sign the petition. As an additional example, if a viewing user is presented with a content item associated with a product or a service and the viewing user has an interest in the content item, the viewing user may click on a “Learn More” button to learn more about the product or the service. In this example, by clicking on the “Learn More” button, a pop-up window providing additional details about the product or the service may then be presented to the viewing user

In some embodiments, an interactive element associated with a content item also may correspond to an option to receive a reminder associated with the content item at a later time. For example, if a viewing user is interested in a content item presented in conjunction with a video, but does not want to interrupt the presentation of the video, the viewing user may click on a “Remind Me Later” button corresponding to an option to receive a reminder associated with the content item at a later time. In embodiments in which an option associated with a content item includes an option to receive a reminder associated with the content item at a later time, the user interface may include additional options associated with the reminder upon receiving a request from a viewing user to receive the reminder associated with the content item. For example, the user interface may include various fields, buttons, or drop-down menus that allow a viewing user to specify when they would like to receive a reminder associated with a content item (e.g., a date and a time) and how they would like to receive the reminder (e.g., in a newsfeed associated with their user account, via email or instant message, etc.).

The user interface module 245 also may generate (e.g., as shown in step 365 of FIG. 3) a reminder associated with a content item. The user interface module 245 may generate a reminder associated with a content item based on information associated with the content item. In embodiments in which information associated with a content item about which a viewing user has requested to be reminded is stored in association with a user account for the viewing user, the user interface module 245 may retrieve this information and generate a reminder based on the retrieved information. For example, if the online system 140 previously stored an identifier associated with a content item in association with a user account for a viewing user in response to receiving a request from the viewing user to receive a reminder associated with the content item at a later time, the user interface module 245 may access the user account store 230 and retrieve the identifier associated with the content item. In this example, based on the identifier associated with the content item, the user interface module 245 may then access the content store 210 and retrieve additional information associated with the content item (e.g., metadata, an image included in the content item, audio data associated with the content item, goods or services featured in the content item, etc.) and generate the reminder based on the retrieved information.

In various embodiments, reminders generated by the user interface module 245 to remind viewing users about content items also may be content items. For example, when the online system 140 identifies an opportunity to send a reminder associated with a content item to a viewing user of the online system 140, the user interface module 245 may generate a reminder associated with the content item in the form of an additional content item. In this example, the additional content item may include the contents of the content item about which the viewing user requested to be reminded and interactive elements corresponding to options associated with the content item that were originally presented with the content item (e.g., an option to subscribe to a service associated with the content item).

In some embodiments, the user interface module 245 also may generate (e.g., as shown in step 370 of FIG. 3) a user interface in which to present a reminder associated with a content item. In embodiments in which the online system 140 reminds a viewing user about a content item via an additional content item, the user interface generated by the user interface module 245 in which to present the reminder may be a feed of content items that includes this additional content item. For example, the online system 140 may identify an opportunity to send a reminder associated with a content item to a viewing user upon receiving a request from the viewing user to access a user profile page associated with the viewing user. In this example, the user interface module 245 may generate a newsfeed that is specific to the viewing user that includes content items reminding the viewing user about other content items.

In various embodiments, the user interface module 245 may generate a dashboard that allows a viewing user to view content items about which the viewing user has requested to be reminded and to perform various actions associated with these content items. For example, upon receiving a request from a viewing user to access a user profile page associated with the viewing user, the user interface module 245 may generate a dashboard that includes a content item associated with a product sample about which the viewing user has requested to be reminded. In this example, the dashboard also may include a set of buttons that each correspond to various options associated with the content item that may be selected by the viewing user (e.g., an option to request the product sample, an option to receive a reminder associated with the content item at a later time, an option to remove the reminder associated with the content item from the dashboard, etc.). The functionality of the user interface module 245 is further described below in conjunction with FIGS. 3-6B.

The web server 250 links the online system 140 via the network 120 to the one or more client devices 110, as well as to the third-party system 130 and/or one or more third-party systems 130. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, WEBOS® or BlackberryOS.

Reminding an Online System User about a Content Item Presented with a Video

FIG. 3 is a flow chart of a method for reminding a user of an online system about a content item presented to the user in conjunction with a video. In other embodiments, the method may include different and/or additional steps than those shown in FIG. 3. Additionally, steps of the method may be performed in a different order than the order described in conjunction with FIG. 3.

The online system 140 may store or maintain 305 a set of user accounts for users of the online system 140 (e.g., in the user account store 230). Various types of user-identifying information that is associated with a user in the online system 140 may be stored in association with a user account for the online system user. In some embodiments, user-identifying information that is stored in association with a user account includes login credentials (e.g., a username/email address and password combination) for a user. For example, when a prospective user of the online system 140 requests to create a user account in the online system 140, the online system 140 may require the user to provide a username that is unique to the user in the online system 140 and a password. In this example, upon receiving a username and a password from the user, the username and the password are stored in association with a user account that is created for the user

User-identifying information that is stored in association with user accounts also may include information associated with tracking mechanisms (e.g., cookies). For example, when a user of the online system 140 requests to access a page maintained in the online system 140, if the request does not include a cookie identifier, the online system 140 may generate a cookie identifier that is unique to the user in the online system 140, and store the cookie identifier in the client device 110. In this example, the online system 140 also may store the cookie identifier in association with a user account for the user.

In some embodiments, user-identifying information that is stored in association with user accounts also may include information associated with client devices 110 associated with users of the online system 140. For example, when the online system 140 receives login credentials from a user of the online system 140, the online system 140 also may receive a client device identifier (e.g, an IP address) in conjunction with the login credentials that are associated with a client device 110 from which the login credentials were received. In this example, if the online system 140 determines that the login credentials are valid (i.e., if the online system 140 determines that the login credentials are associated with a user account maintained in the online system 140), the online system 140 may store the client device identifier in association with a user account for the user. In the above example, the online system 140 also may store additional types of information associated with the client device 110 in association with the user account for the user, such as a browser identifier, an operating system identifier, etc.

In various embodiments, user-identifying information that is stored in association with user accounts may include various types of information that also is stored in the user profile store 205. For example, each user account for a user of the online system 140 may be stored in association with a first name, a last name, and a birthdate of the user. As an additional example, each user account for an online system user may be stored in association with an email address, a home address, and a phone number associated with the user.

The online system 140 receives 310 (e.g., using the action logger 215) a request from a viewing user of the online system 140 to view a video maintained in the online system 140. For example, the online system 140 may receive a set of search parameters (e.g, keywords) entered by a viewing user into a search field included in a user interface presented by the online system 140. In this example, upon receiving the search parameters, the online system 140 may present a set of results that includes videos that are associated with information that matches at least a threshold number of the search parameters. Continuing with this example, the online system 140 then receives 310 a request from the viewing user to view a video from the set of results. The online system 140 may receive 310 the request via a client device 110 associated with the viewing user. For example, the online system 140 receives 310 the request from a mobile device or from a desktop computer associated with a viewing user.

In some embodiments, upon receiving 310 the request from the viewing user to view the video, the online system 140 may identify 315 (e.g., using the user identification module 235) the viewing user from which the request was received 310. The online system 140 may identify 315 the viewing user across different sessions within the online system 140 based on various types of user-identifying information that is unique to each user in the online system 140. In some embodiments, the online system 140 may identify 315 users of the online system 140 across different sessions within the online system 140 based on login credentials for each user. For example, the online system 140 may require each user of the online system 140 to provide login credentials at the start of each session in the online system 140. In this example, when the online system 140 receives login credentials from a user, the online system 140 may identify 315 the viewing user to be the online system user having a user account associated with the login credentials. In various embodiments, the online system 140 may identify 315 users of the online system 140 across different sessions within the online system 140 using one or more tracking mechanisms (e.g., cookies). For example, when a user of the online system 140 requests to access a page maintained in the online system 140, if the request includes a cookie identifier, the online system 140 may identify 315 the viewing user to be the online system user having a user account associated with the cookie identifier.

The online system 140 may determine 320 (e.g., using the content selection module 240) if a content item should be presented to the viewing user in conjunction with the video. The online system 140 may determine 320 that a content item should be presented to the viewing user in conjunction with the video if certain conditions are met. In some embodiments, the online system 140 determines 320 that a content item should be presented to the viewing user in conjunction with a video if the online system 140 has received a given number of requests to present videos to the viewing user. For example, the online system 140 determines 320 that for every three requests received by the online system 140 to present videos to a viewing user of the online system 140, a content item should be presented to the viewing user in conjunction with the video presented in response to the third request. In some embodiments, the online system 140 may determine 320 that a content item should be presented to the viewing user in conjunction with a video if the online system 140 has received a minimum number of requests to present videos to the viewing user. For example, the online system 140 determines 320 that for every other request received by the online system 140 to present videos to the viewing user, a content item should be presented to the viewing user in conjunction with at least one of the videos presented in response to the requests.

In embodiments in which the online system 140 determines 320 if a content item should be presented to a viewing user in conjunction with a video based on a given or on a minimum number of requests to present videos to the viewing user, the given/minimum number of requests may be determined based on information specified by a content-providing user of the online system 140 associated with the content item. For example, if a content item is an advertisement, an advertiser who provided the advertisement to the online system 140 may specify that the advertisement should be presented 1,000 times per day. In this example, based on the information specified by the advertiser, the online system 140 may adjust the frequency with which the advertisement is presented to viewing users of the online system 140 in order to achieve the 1,000 presentations per day.

The online system 140 may determine the conditions under which content items should be presented to viewing users in conjunction with videos. In some embodiments, the online system 140 experiments with presenting content items to viewing users in conjunction with videos at various times and determines a set of optimal conditions under which the content items should be presented to viewing users in conjunction with videos. For example, the online system 140 may vary the frequency with which content items are presented to the same viewing users in conjunction with videos and the times at which content items are presented while the videos are playing. In this example, the online system 140 may determine optimal times during which content items should be presented in conjunction with videos based on the viewing users' responses (e.g., based on whether the viewing users clicked on the content items, closed the content items, navigated away from the online system 140, etc.). Continuing with this example, the online system 140 may determine that content items should be presented in conjunction with videos upon receiving every three requests from the same viewing user to view videos and that content items should be presented in conjunction with videos three seconds after videos begin playing.

In embodiments in which the online system 140 determines 320 that a content item should not be presented in conjunction with the video, the online system 140 may present the video to the viewing user of the online system 140 without a content item. In such embodiments, the online system 140 may then determine 320 if a content item should be presented to the viewing user upon receiving 310 a subsequent request from the viewing user to view a video.

Upon determining 320 that a content item should be presented to the viewing user in conjunction with the video, the online system 140 may identify 325 (e.g., using the content selection module 240) a content item to present to the viewing user. In some embodiments, the online system 140 may identify 325 the content item to present to the viewing user in conjunction with the video by selecting the content item from various content items maintained in the online system 140. For example, the online system 140 may select a set of candidate content items maintained in the content store 210 to present to a viewing user in conjunction with a video based on attributes associated with the viewing user (e.g., demographic information associated with the viewing user stored in the user profile store 205) that satisfy one or more targeting criteria associated with each candidate content item. In this example, the online system 140 may then compute a score for each candidate content item that indicates a predicted affinity of the viewing user for the candidate content item and select a content item having the highest score for presentation to the viewing user in conjunction with the video. In various embodiments, the online system 140 may identify 325 multiple content items to present to the viewing user in conjunction with the video. In the above example, the online system 140 may rank the candidate content items based on their scores and select two or more of the candidate content items having the highest scores for presentation to the viewing user in conjunction with the video.

The online system 140 generates 330 (e.g., using the user interface module 245) a user interface for presenting the content item to the viewing user in conjunction with the video. The user interface generated 330 by the online system 140 may include a display area for presenting the content item in conjunction with the video. In various embodiments, the video and the content item are arranged within the display area of the user interface such that the content item overlays at least a portion of the video. For example, if the online system 140 generates 330 a user interface that includes a display area in which a video and a content item are to be displayed, the online system 140 may arrange the video and the content item in the display area by overlaying the content item onto the video, such that when the user interface is presented to a viewing user, at least a portion of the video onto which the content item is overlaid is not visible. Alternatively, in the above example, the content item may be partially transparent, such that, when the user interface is presented to the viewing user, at least a portion of the video onto which the content item is overlaid is only partially visible. In embodiments in which the online system 140 identifies 325 multiple content items to present to the viewing user, the content items may be arranged within the display area of the user interface such that one or more of the content items overlay at least a portion of the video.

The user interface also may include a set of interactive elements (e.g., buttons) that each correspond to an option associated with the content item. Each interactive element associated with the content item may correspond to an option associated with the content item that may be selected by the viewing user. An example of an option associated with the content item that may be selected by the viewing user is an option to close the content item. For example, if a viewing user is presented with a content item (e.g., a direct response advertisement associated with a product) and the viewing user has no interest in the content item, the viewing user may click on a button presented with the content item corresponding to an option to close the content item (e.g., a “Close” button or a button marked with an “X”).

Another example of an option associated with the content item that may be selected by the viewing user is an option to perform an action associated with the content item. In some embodiments, an option to perform an action associated with the content item may correspond to an option to make a purchase associated with the content item, an option to visit a website associated with the content item, an option to express a preference for the content item, an option to share the content item, an option to comment on the content item, an option to sign a petition associated with the content item, an option to try a sample associated with the content item, etc. For example, if a viewing user is presented with a content item associated with a newsletter and the viewing user is interested in the content item, the viewing user may click on a “Subscribe Now” button presented with the content item corresponding to an option to subscribe to the newsletter. In this example, by clicking on the “Subscribe Now” button, the viewing user may be redirected to a landing page associated with the content item at which the viewing user may subscribe to the newsletter. As an additional example, if a viewing user is presented with a content item associated with a music album and the viewing user has an interest in the content item, the viewing user may click on a “Listen Now” button to listen to a sample of the album. In this example, by clicking on the “Listen Now” button, a pop-up window providing additional details about the album (e.g., how to download the album), may then be presented to the viewing user.

In some embodiments, an interactive element associated with the content item also may correspond to an option to receive a reminder associated with the content item at a later time. For example, if a viewing user is interested in a content item presented in conjunction with a video, but does not want to interrupt the presentation of the video, the viewing user may click on a “Remind Me Later” button corresponding to an option to receive a reminder associated with the content item at a later time. In embodiments in which an option associated with the content item includes an option to receive a reminder associated with the content item at a later time, the user interface may include additional options associated with the reminder upon receiving a request from the viewing user to receive the reminder associated with the content item. For example, the user interface may include various fields, buttons, or drop-down menus that allow a viewing user to specify when they would like to receive a reminder associated with a content item (e.g., a date and a time) or how they would like to receive the reminder (e.g, in a newsfeed associated with their user account, via email or text message, etc.).

In embodiments in which the online system 140 identifies 325 multiple content items to present to the viewing user, the user interface also may include multiple sets of interactive elements (e.g., buttons) that correspond to options associated with each content item that may be selected by the viewing user presented with the content item. For example, if the user interface includes a display area in which two content items are presented in conjunction with a video, each content item may be associated with an option to close the content item, an option to perform an action associated with the content item, and an option to receive a reminder associated with the content item at a later time.

Once the online system 140 has generated 330 the user interface, the online system 140 may send 335 the user interface for display to the viewing user. The online system 140 may send 335 the user interface for display to the viewing user via a client device 110 associated with the viewing user. For example, the online system 140 may send 335 the user interface to a mobile device associated with a viewing user. In this example, the user interface may be presented to the viewing user in a display area of the mobile device.

The content item may be presented in conjunction with the video via the user interface at any time after the online system 140 receives a request from the viewing user to begin to play the video, but before the online system 140 receives information indicating that the video has finished playing. For example, when the user interface is sent 335 for display to a viewing user, a content item may be presented in conjunction with the video in a display area of the user interface at the time the video begins to play. Alternatively, in the above example, when the user interface is sent 335 for display to the viewing user, the content item may be presented in conjunction with the video in the display area a few seconds after the video begins to play. In some embodiments, the online system 140 may present a set of interactive elements associated with the content item at the same time that the content item is presented. In other embodiments, the online system 140 may delay the presentation of the set of interactive elements associated with the content item. For example, the online system 140 may delay the presentation of a set of interactive elements associated with a content item a few seconds after the content item is initially presented.

In various embodiments, once the viewing user selects an option associated with the content item, the content item is removed from the display area of the user interface in which the video is presented. For example, if a content item is overlaid onto a video in a display area of a user interface sent 335 for display to a viewing user and the viewing user clicks on a button corresponding to an option to close the content item, the content item is removed from the display area. In the above example, the content item also may be removed from the display area if the viewing user clicks on a button corresponding to an option to receive a reminder associated with the content item at a later time.

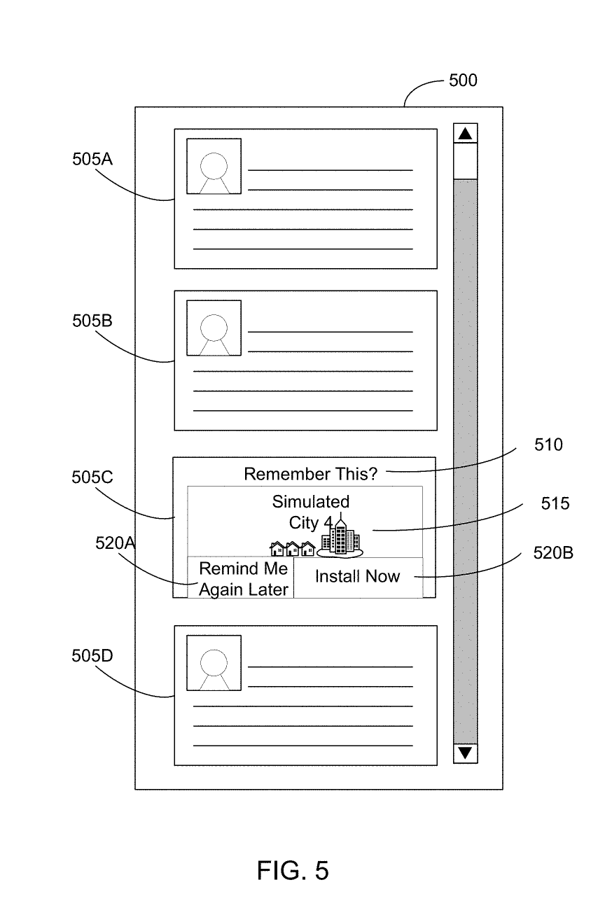

In the example of FIG. 4, a display area 400 of a user interface includes a video 405 and a content item 410 that are arranged such that the content item 410 overlays the lower right-hand corner of the video 405 being presented. In this example, the content item 410 is associated with a game application called “Simulated City 4” and is presented five seconds into the video 405 that is being presented. Also, in this example, the content item 410 is presented in conjunction with buttons corresponding to various options associated with the content item 410 that may be selected by a viewing user being presented with the content item 410. The button 415A marked with an “X” would allow the viewing user to close the content item 410, the “Install Now” button 415B would allow the viewing user to install the game application on a client device 110 associated with the viewing user, and the “Remind Me Later” button 415C would allow the viewing user to request to receive a reminder associated with the content item 410.

Referring back to FIG. 3, the online system 140 may receive 340 (e.g., using the action logger 215) a request from the viewing user to receive a reminder associated with the content item. For example, the online system 140 receives 340 a request from a viewing user to receive a reminder associated with a content item if the viewing user clicks on a button corresponding to an option to receive the reminder associated with the content item presented in conjunction with a video. In some embodiments, the online system 140 also may receive 340 additional information from the viewing user specifying when and how they would like to receive the reminder associated with the content item. For example, the user interface may include fields, buttons, or drop-down menus associated with an option to receive a reminder associated with a content item that allow a viewing user to specify when they would like to receive the reminder (e.g., one day or one week from now) and how they would like to receive the reminder (e.g., in a dashboard associated with their user account, via email or calendar reminder, etc.).

In some embodiments, upon presenting the content item to the viewing user, the online system 140 may communicate 345 information describing the presentation of the content item to a content-providing user of the online system 140. Information describing the presentation of the content item may include information describing an impression of the content item or an action performed by the viewing user in association with being presented with the content item. For example, a content item (e.g., an advertisement) may be associated with one or more bid amounts previously provided by a content-providing user of the online system 140 (e.g., an advertiser) associated with the content item that specify prices the content-providing user is willing to pay in exchange for each impression or for each conversion associated with the content item. In this example, the content-providing user may be charged the bid amount when the online system 140 has presented a video in conjunction with the content item to a viewing user of the online system 140, when the online system 140 receives a request from a viewing user to receive a reminder associated with the content item at a later time, or when the online system 140 receives a request from a viewing user to perform an action associated with the content item.

Responsive to receiving 340 the request from the viewing user to receive the reminder associated with the content item, the online system 140 may store 350 information associated with the content item in association with a user account maintained in the online system 140 for the viewing user (e.g., in the user account store 230). Information associated with the content item that may be stored 350 in association with the user account may include images, text, or other content included in the content item, metadata associated with the content item, information describing a set of options associated with the content item, etc. For example, if the online system 140 receives 340 a request from a viewing user to receive a reminder associated with a content item about a new edition of book that is about to be released, the online system 140 may store 350 information associated with the content item in association with the user's user account, such as a date that the book will be available for purchase, the names and locations of retailers that will be selling the book, the names of one or more authors of the book, a genre associated with the book, formats in which the book will be available (e.g., eBook, paperback, or hardcover), etc.

In some embodiments, the online system 140 also may store 350 information describing the viewing user's request to receive a reminder associated with a content item in association with their user account. For example, if the online system 140 receives 340 a request to remind a viewing user about a content item by pop-up window at a specific time, the online system 140 may store 350 information in association with a user account for the viewing user including an identifier associated with the content item, the specified time, and an indication that the reminder is to be sent via a pop-up window. As an additional example, if the online system 140 receives 340 a request to remind a viewing user about a content item via email an hour later, the online system 140 may store 350 information in association with a user account for the user including information associated with the content item, the time that the online system 140 received the request to remind the user about the content item, and an indication that the reminder is to be sent via email an hour after the request was received.

In some embodiments, if the online system 140 has received 340 a request from the viewing user of the online system 140 to receive a reminder associated with the content item, the online system 140 may identify 355 an opportunity to send the reminder to the viewing user. In one embodiment, the online system 140 identifies 355 such an opportunity upon receiving information indicating that the video that was presented in conjunction with the content item has finished playing. For example, the online system 140 may identify 355 an opportunity to send a reminder associated with a content item to a viewing user upon receiving information indicating that the viewing user has navigated away from the online system 140 or from a video presented in conjunction with the content item.

The online system 140 also may identify 355 an opportunity to send a reminder associated with the content item to the viewing user based on contextual information associated with the viewing user and/or with the content item. For example, if a content item is associated with a game application and with an option to install the game application, the online system 140 may identify 355 an opportunity to send a reminder associated with the content item to a viewing user at a time that would allow the application to be installed under optimal conditions. In this example, the online system 140 may determine that conditions are optimal when the online system 140 detects that a client device 110 associated with the viewing user is connected to a WiFi network.

In embodiments in which the viewing user specifies a date and/or a time at which they would like to receive a reminder associated with the content item, the online system 140 may identify 355 an opportunity to send the reminder on the date and/or time specified by the viewing user. For example, if the online system 140 receives 340 a request from a viewing user to receive a reminder associated with a content item in an hour, the online system 140 may identify 355 an opportunity to send the reminder to the viewing user once an hour has elapsed since the request was received 340.

In some embodiments, the online system 140 may identify 355 an opportunity to send a reminder associated with the content item to the viewing user upon receiving a request from the viewing user to access content associated with the viewing user's user account. For example, the online system 140 may identify 355 an opportunity to send a reminder associated with a content item to a viewing user upon receiving a request from the viewing user to access a user profile page associated with the viewing user. As an additional example, the online system 140 may identify 355 an opportunity to send a reminder associated with a content item to a viewing user upon receiving a request from the viewing user to access a message inbox associated with the viewing user's user account in the online system 140.

Upon identifying 355 an opportunity to send a reminder associated with a content item to the viewing user, the online system 140 may retrieve 360 the information associated with the content item stored in association with the user account for the viewing user. For example, if a viewing user requested to receive a reminder about a content item associated with a sale at a department store, upon identifying 355 an opportunity to send the reminder to the viewing user, the online system 140 may access a user account for the viewing user and retrieve 360 information associated with the content item previously stored 350 in association with the user account. In this example, information associated with the content item may include the name of the department store, details about the sale (e.g., dates during which the sale is running, discounts available during the sale, coupon codes included in the content item, etc.), options associated with the content item that were originally presented with the content item by the viewing user, etc. In embodiments in which the viewing user also specified how and/or when they would like to receive the reminder associated with the content item, the online system 140 may retrieve 360 this information as well. In the above example, the online system 140 also may retrieve 360 information specified by the viewing user indicating that they would like to receive the reminder by email.

The online system 140 may then generate 365 (e.g., using the user interface module 245) the reminder associated with the content item. The online system 140 may generate 365 the reminder associated with the content item based at least in part on information associated with the content item stored 350 in association with the user account for the viewing user. For example, if the online system 140 previously stored 350 an identifier associated with a content item in association with a user account for a viewing user in response to receiving 340 a request from the viewing user to receive a reminder associated with the content item at a later time, the online system 140 may access the user account and retrieve 360 the identifier associated with the content item upon identifying 355 an opportunity to send the reminder to the viewing user. In this example, based on the identifier associated with the content item, the online system 140 may then access the content store 210 and retrieve 360 additional information associated with the content item (e.g., metadata, an image included in the content item, audio data associated with the content item, goods or services featured in the content item, etc.) and generate 365 the reminder based on the retrieved information.

In various embodiments, reminders generated 365 by the online system 140 to remind the viewing user about the content item also may be a content item. For example, when the online system 140 identifies 355 an opportunity to send a reminder associated with a content item to a viewing user of the online system 140, the online system 140 may generate 365 an additional content item to remind the viewing user about the content item. In this example, the additional content item may include the contents included in the content item about which the viewing user requested to be reminded and interactive elements corresponding to options associated with the content item that were originally presented with the content item (e.g., an option to download an application associated with the content item).

In some embodiments, the online system 140 also may generate 370 (e.g., using the user interface module 245) a user interface in which to present the reminder associated with the content item. In embodiments in which the reminder generated 365 by the online system 140 to remind the viewing user about the content item is an additional content item, the user interface generated 370 by the online system 140 in which to present the reminder may be a feed of content items that includes this additional content item. For example, the online system 140 may identify 355 an opportunity to send a reminder associated with a content item to a viewing user upon receiving a request from the viewing user to access a user profile page associated with the viewing user. In this example, the online system 140 may generate 370 a newsfeed that is specific to the viewing user that includes content items reminding the viewing user about other content items.

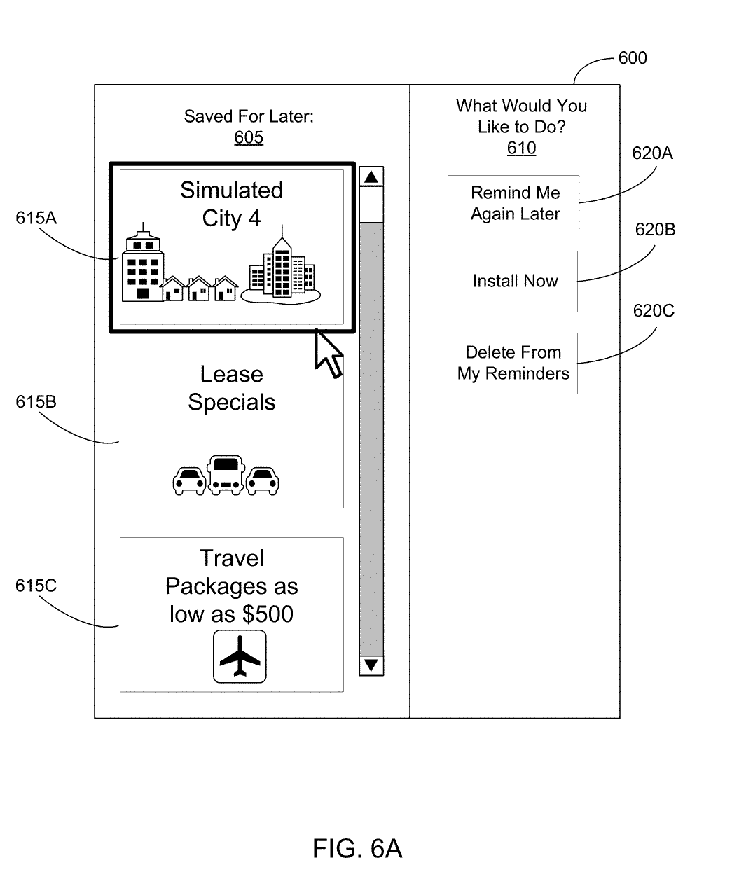

As shown in the example of FIG. 5, the user interface generated 370 by the online system 140 for presenting a reminder associated with the content item may be a scrollable newsfeed 500 that includes multiple content items 505. The content items 505 in the newsfeed 500 may be arranged within the newsfeed 500 based on a ranking of the content items 505. For example, the content items 505 may be ranked based on a predicted affinity of a viewing user for each content item 505, such that the content item 505A in the most prominent position in the newsfeed 500 is associated with the highest predicted affinity, the content item 505B in the second most prominent position in the newsfeed 500 is associated with the second highest predicted affinity, etc. In this example, the content item 505C in the third most prominent position in the newsfeed 500 is a reminder about a content item 515 associated with a game application called “Simulated City 4” that previously was presented to the viewing user. This content item 505C may include a heading 510 (e.g., “Remember This?”) that indicates that the content item 505C is a reminder about another content item 515. The content item 505C also may include a “Remind Me Again Later” button 520A that allows the viewing user to request to receive another reminder associated with the content item and an “Install Now” button 520B corresponding to an option to download the game application.

In various embodiments, the user interface generated 370 by the online system 140 in which to present a reminder may be a dashboard that allows the viewing user to view a content item about which the viewing user has requested to be reminded and to perform various actions associated with the content item. For example, upon receiving a request from a viewing user to access a user profile page associated with the viewing user, the online system 140 may generate 370 a dashboard that includes a content item associated with a product sample about which the viewing user has requested to be reminded. In this example, the dashboard also may include a set of buttons that each correspond to various options associated with the content item that may be selected by the viewing user (e.g., an option to request the product sample, an option to receive a reminder associated with the content item at a later time, an option to remove the reminder associated with the content item from the dashboard, etc.).

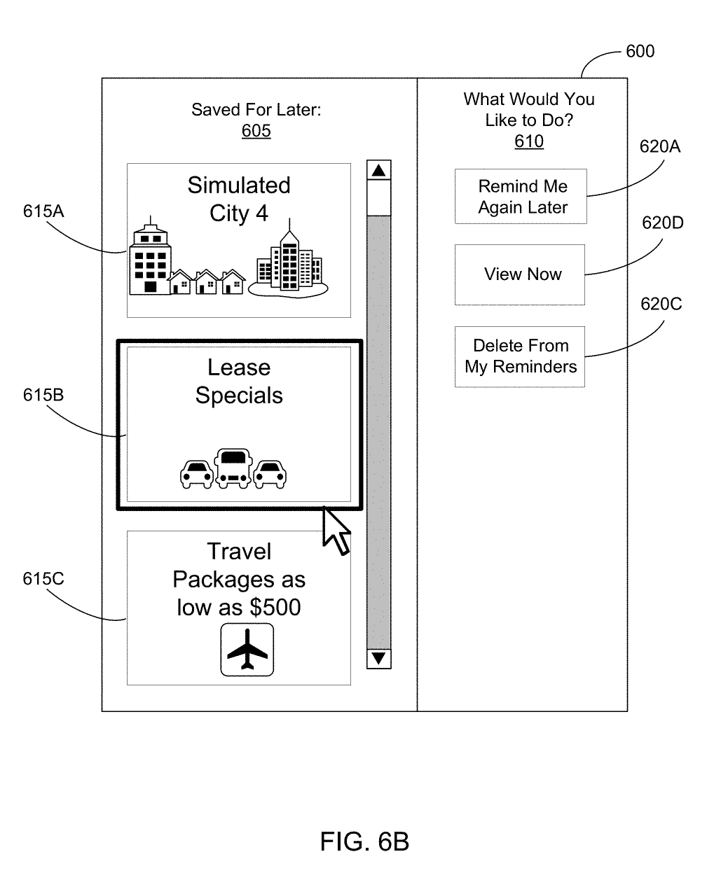

In some embodiments, a dashboard generated 370 by the online system 140 may include reminders about multiple content items. As shown in the example of FIG. 6A, the dashboard 600 generated 370 by the online system 140 includes a scrollable left-hand portion 605 that allows the viewing user to view content items 615A-C about which the viewing user has requested to be reminded. These content items 615A-C may be arranged based on an order in which the viewing user requested to be reminded about the content items (e.g., in chronological order or in reverse chronological order) or based on any other suitable ordering technique. The dashboard 600 also includes a right-hand portion 610 that allows the viewing user to perform various actions associated with the content items 615A-C in the left-hand portion 605 of the dashboard 600. As shown in this example, upon receiving a request from the viewing user to perform an action associated with the content item 615A associated with a game application named “Simulated City 4,” the right-hand portion 610 of the dashboard 600 generated 370 by the online system 140 may include a set of buttons that each correspond to various options associated with the content item 615A that may be selected by the viewing user. In this example, the buttons include a “Remind Me Again Later” button 620A that allows the viewing user to request to receive an additional reminder associated with the content item 615A, an “Install Now” button 620B that allows the viewing user to install the game application on a client device 110 associated with the viewing user, and a “Delete From My Reminders” button 620C that allows the viewing user to remove the reminder associated with the content item 615A from the dashboard, etc.).

As shown in the additional example of FIG. 6B, upon receiving a request from the viewing user to perform an action associated with the content item 615B associated with lease options for various cars, the right-hand portion 610 of the dashboard 600 generated 370 by the online system 140 may include a set of buttons that each correspond to various options associated with the content item 615B that may be selected by the viewing user. In this example, the buttons include a “Remind Me Again Later” button 620A that allows the viewing user to request to receive an additional reminder associated with the content item 615B, a “View Now” button 620D that allows the viewing user to view the lease options associated with the content item 615B, and a “Delete From My Reminders” button 620C that allows the viewing user to remove the reminder associated with the content item 615B from the dashboard, etc.).

Referring back to FIG. 3, the online system 140 sends 375 the reminder associated with the content item for display to the viewing user. The online system 140 may send 375 the reminder associated with the content item to the viewing user using various mechanisms. In some embodiments, the online system 140 may send 375 the reminder associated with the content item to the viewing user using one or more types of notifications. Examples of notifications include alerts, text messages, emails, or any other suitable types of notifications. For example, the online system 140 may send 375 a notification to remind a viewing user about a content item via a pop-up window. As an additional example, the online system 140 may send 375 a message to an inbox associated with a viewing user's account maintained in the online system 140 reminding the viewing user about a content item and notify the viewing user of the message by email.

In embodiments in which the online system 140 generates 370 a user interface in which to present a reminder associated with the content item, the online system 140 may send 375 the reminder associated with the content item to the viewing user via the user interface. For example, the online system 140 may send 375 a newsfeed to the viewing user, in which the newsfeed includes a reminder associated with the content item in the form of an additional content item. As an additional example, the online system 140 may send 375 a dashboard to the viewing user, in which the dashboard includes one or more reminders associated with one or more content items.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
receiving, at an online system, a request from a viewing user of the online system to view a video maintained in the online system;
identifying a content item to present to the viewing user in conjunction with the video;
generating a user interface comprising a display area and an interactive element, wherein the display area comprises an arrangement of the video and the content item such that the content item overlays at least a portion of the video and the interactive element corresponds to an option to receive a reminder associated with the content item at a later time;
sending the user interface for display to the viewing user;
while the video is playing, receiving a request from the viewing user via the interactive element to receive the reminder associated with the content item at the later time;
responsive to receiving the request from the viewing user while the video is playing to receive the reminder associated with the content item at the later time via the interactive element, storing information associated with the content item in association with a user account for the viewing user;
identifying an opportunity after the video has been displayed to send the reminder associated with the content item to the viewing user;
retrieving the information associated with the content item stored in association with the user account for the viewing user;
generating the reminder associated with the content item based at least in part on the information associated with the content item stored in association with the user account for the viewing user; and
sending the reminder associated with the content item for display to the viewing user.

2. The method of claim 1, wherein identifying the opportunity to send the reminder associated with the content item to the viewing user comprises:
receiving information indicating that the viewing user has finished viewing the video.

3. The method of claim 1, wherein the information associated with the content item comprises a product or a service associated with the content item.

4. The method of claim 1, wherein the reminder associated with the content item comprises an additional content item.

5. The method of claim 4, further comprising:
generating a ranked feed of content items comprising the additional content item.

6. The method of claim 5, wherein sending the reminder associated with the content item for display to the viewing user comprises:
sending the feed of content items for display to the viewing user.

7. The method of claim 1, further comprising:
generating a dashboard for displaying content items about which the viewing user has requested to be reminded, the dashboard comprising the reminder associated with the content item.

8. The method of claim 7, wherein sending the reminder associated with the content item for display to the viewing user comprises:
sending the dashboard for display to the viewing user.

9. The method of claim 1, wherein the content item is identified in response to receiving a specified number of requests from the viewing user to view one or more videos.

10. The method of claim 1, wherein the request from the viewing user to receive the reminder associated with the content item comprises one or more of: a time at which the viewing user is to receive the reminder associated with the content item and a manner in which the viewing user is to receive the reminder associated with the content item.

11. The method of claim 1, wherein identifying the opportunity to send the reminder associated with the content item to the viewing user comprises:
detecting a set of optimal conditions associated with the viewing user.

12. A computer program product comprising a non-transitory computer readable storage medium having instructions encoded thereon that, when executed by a processor, cause the processor to:
receive, at an online system, a request from a viewing user of the online system to view a video maintained in the online system;
identify a content item to present to the viewing user in conjunction with the video;
generate a user interface comprising a display area and an interactive element, wherein the display area comprises an arrangement of the video and the content item such that the content item overlays at least a portion of the video and the interactive element corresponds to an option to receive a reminder associated with the content item at a later time;
send the user interface for display to the viewing user;
while the video is playing, receive a request from the viewing user via the interactive element to receive the reminder associated with the content item at the later time;
responsive to receiving the request from the viewing user to receive the reminder associated with the content item at the later time via the interactive element, store information associated with the content item in association with a user account for the viewing user;
identify an opportunity after the video has been displayed to send the reminder associated with the content item to the viewing user;
retrieve the information associated with the content item stored in association with the user account for the viewing user;
generate the reminder associated with the content item based at least in part on the information associated with the content item stored in association with the user account for the viewing user; and
send the reminder associated with the content item for display to the viewing user.

13. The computer program product of claim 12, wherein identify the opportunity to send the reminder associated with the content item to the viewing user comprises:
receive information indicating that the viewing user has finished viewing the video.

14. The computer program product of claim 12, wherein the information associated with the content item comprises a product or a service associated with the content item.

15. The computer program product of claim 12, wherein the reminder associated with the content item comprises an additional content item.

16. The computer program product of claim 15, wherein the computer readable storage medium further has instructions encoded thereon that, when executed by the processor, cause the processor to:
generate a ranked feed of content items comprising the additional content item.

17. The computer program product of claim 16, wherein send the reminder associated with the content item for display to the viewing user comprises:
send the feed of content items for display to the viewing user.

18. The computer program product of claim 12, wherein the computer readable storage medium further has instructions encoded thereon that, when executed by the processor, cause the processor to:
generate a dashboard for displaying content items about which the viewing user has requested to be reminded, the dashboard comprising the reminder associated with the content item.

19. The computer program product of claim 18, wherein send the reminder associated with the content item for display to the viewing user comprises:
send the dashboard for display to the viewing user.

20. The computer program product of claim 12, wherein the content item is identified in response to receiving a specified number of requests from the viewing user to view one or more videos.

21. The computer program product of claim 12, wherein the request from the viewing user to receive the reminder associated with the content item comprises one or more of: a time at which the viewing user is to receive the reminder associated with the content item and a manner in which the viewing user is to receive the reminder associated with the content item.

22. The computer program product of claim 12, wherein identify the opportunity to send the reminder associated with the content item to the viewing user comprises:
detect a set of optimal conditions associated with the viewing user.

23. A method comprising:
receiving, at an online system, a request from a viewing user of the online system to view a video maintained in the online system;
sending a user interface for display to the viewing user, the user interface comprising a display area and an interactive element, wherein the display area comprises an arrangement of the video and the content item such that the content item overlays at least a portion of the video and the interactive element corresponds to an option to receive a reminder associated with the content item at a later time;
while the video is playing, receiving a request from the viewing user to receive the reminder associated with the content item at the later time via the interactive element;
responsive to determining that the viewing user has finished viewing the video, identifying an opportunity to send the reminder associated with the content item to the viewing user based on detecting a set of optimal conditions associated with the viewing user;
generating the reminder associated with the content item; and
sending the reminder associated with the content item for display to the viewing user.

24. The method of claim 23, further comprising:
responsive to receiving the request from the viewing user to receive the reminder associated with the content item at the later time via the interactive element, storing information associated with the content item in association with a user account for the viewing user.

25. The method of claim 24, wherein generating the reminder associated with the content item comprises:
generating the reminder associated with the content item based at least in part on the information associated with the content item stored in association with the user account for the viewing user.
